(19) United States
(12) Patent Application Publication
(10) Pub. No.: US 2020/0323730 A1
(43) Pub. Date: Oct. 15, 2020

(54) Device and Method for Treatment of Equine Neonatal Maladjustment Syndrome

(71) Applicant: Monty L. Ruetenik, Clear Lake Shores, TX (US)

(72) Inventor: Monty L. Ruetenik, Clear Lake Shores, TX (US)

(21) Appl. No.: 16/840,957

(22) Filed: Apr. 6, 2020

Related U.S. Application Data
(60) Provisional application No. 62/832,168, filed on Apr. 10, 2019.
(60) Provisional application No. 62/879,917, filed on Jul. 29, 2019.

(51) Int. Cl. A61H 9/00; A61H 11/00

(52) U.S. Cl. CPC A61H 9/0078; A61H 2011/005; A61H 2203/03; A61H 11/00

(57) ABSTRACT

A device and method for the treatment of equine neonatal maladjustment syndrome and more specifically to a strap system with pressure bags to provide pressure to the bodies of newborn equine foals. The device simulates the rope procedure described in recent and is simpler to use, more effective and more reliable. It is designed to provide a qualified treatment that can be administered by inexperience farm staff can do in a rural setting.

### BACKGROUND FIELD

This invention relates to a device and method for the treatment of equine neonatal maladjustment syndrome and more specifically to a strap system with pressure bags to provide pressure to the bodies of newborn equine foals.

### BACKGROUND

As reported by the University of California, Davis, “The horse disorder, known as equine neonatal maladjustment syndrome, has puzzled horse owners and veterinarians for a century. Foals affected by the disorder seem detached, fail to recognize their mothers and have no interest in nursing. In newborn foals, neonatal maladjustment syndrome, or dummy foal syndrome, occurs in 3-5% of live births. With around-the-clock bottle or tube feeding plus intensive care in a veterinary clinic for up to a week or 10 days, 80% of the foals recover. But for horse owners, that level of care is grueling and costly. For years, the syndrome has been attributed to hypoxia—insufficient oxygen during the birthing process. Madigan and UC Davis veterinary neurologist Monica Aleman began sleuthing around for other potential causes, however, noting that hypoxia usually causes serious, permanent damage, while most foals with the maladjustment syndrome survive with no lingering health problems.”

One of their prime suspects was a group of naturally occurring neurosteroids, which are key to sustaining pregnancies in horses, especially in keeping the foal “‘quiet’” before birth.

“‘Foals don't gallop in utero,’” Madigan is fond of saying, pointing out the dangers to the mare if a four-legged, hoofed fetus were to suddenly become active in the womb. The prenatal calm is made possible, he explained, by neurosteroids that act as sedatives for the unborn foal. However, immediately after birth, the infant horse must make an equally important transition to consciousness. In nature, a baby horse would be easy prey for many natural enemies, so the foal must be ready to run just a few hours after it is born.”

In short, somewhere between the time a foal enters the birth canal and the moment it emerges from the womb, a biochemical “‘on switch’” must be flicked that enables the foal to recognize the mare, nurse and become mobile. Madigan and Aleman suspect that the physical pressure of the birthing process may be that important signal.”

“‘We believe that the pressure of the birth canal during the second stage of labor, which is supposed to last 20 to 40 minutes, is an important signal that tells the foal to quit producing the sedative neurosteroids and “‘wake up,’” Madigan said.

Amazingly, the veterinary researchers have found that they can reduce maladjustment symptoms in foals by using several loops of a soft rope to gently squeeze the foal's upper torso and mimic the pressure normally experienced in the birth canal. When pressure is applied with the rope, the foal lies down and appears to be asleep.”

After 20 minutes—about the same time a foal would spend in the birth canal—the rope is loosened and the squeeze pressure released. In initial cases, the foals have responded well to the procedure and recovered, some rising to their feet within minutes and bounding over to join the mare and nurse.”

The researchers suspect that the pressure triggers biochemical changes in the central nervous system that are critical for transitioning the foal from a sleeplike state in the womb to wakefulness at birth.” Madigan Foal Squeeze Procedure for Neonatal Maladjustment Syndrome: Newborn foals may offer clues to autism in humans.” University of California, Davis; Feb. 4, 2015.

### SUMMARY

The present invention is a device to simulate the rope procedure described in the research noted in the Background above that is simpler to use, more effective and more reliable. It is designed to provide a qualified treatment that can be administered by inexperience farm staff can do in a rural setting

### BRIEF DESCRIPTION OF THE DRAWINGS

FIG. 1 is a top side view of an embodiment of a strap of the invention.

FIG. 1A is a perspective view of an embodiment of the invention showing the surrounding strap and location of pressure bags.

FIG. 2 is a top view of a strap of an embodiment of the invention.

FIG. 3 is a top view of a bottom layer of a strap of an embodiment of the invention showing placement of inflatable bags and connector elements.

FIG. 4 is an end view of the embodiment of FIG. 3, enlarged and not to scale.

FIG. 5 is another top view of a bottom layer of an embodiment of a strap of the invention showing placement of a sectioned inflatable structure and connector elements.

FIG. 6 is a top view of a bottom layer of an embodiment of a strap of the invention showing placement of a surrounding fabric blanket.

FIG. 7 is an end view of the embodiment of FIG. 6, enlarged and not to scale.

FIG. 7A is a schematic representation of an embodiment of the invention showing arrangement of pressure control elements.

FIG. 7B is a schematic representation of another embodiment of the invention showing arrangement of pressure control elements.

### DETAILED DESCRIPTION

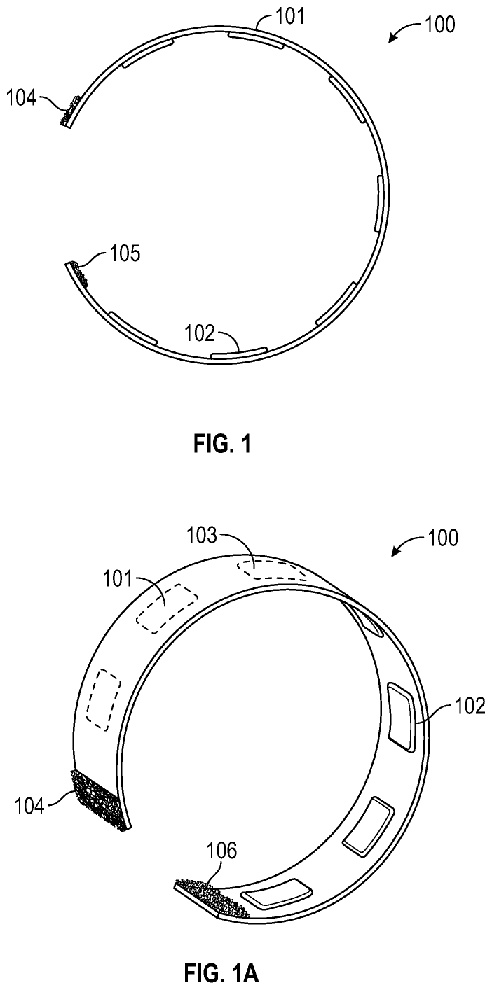

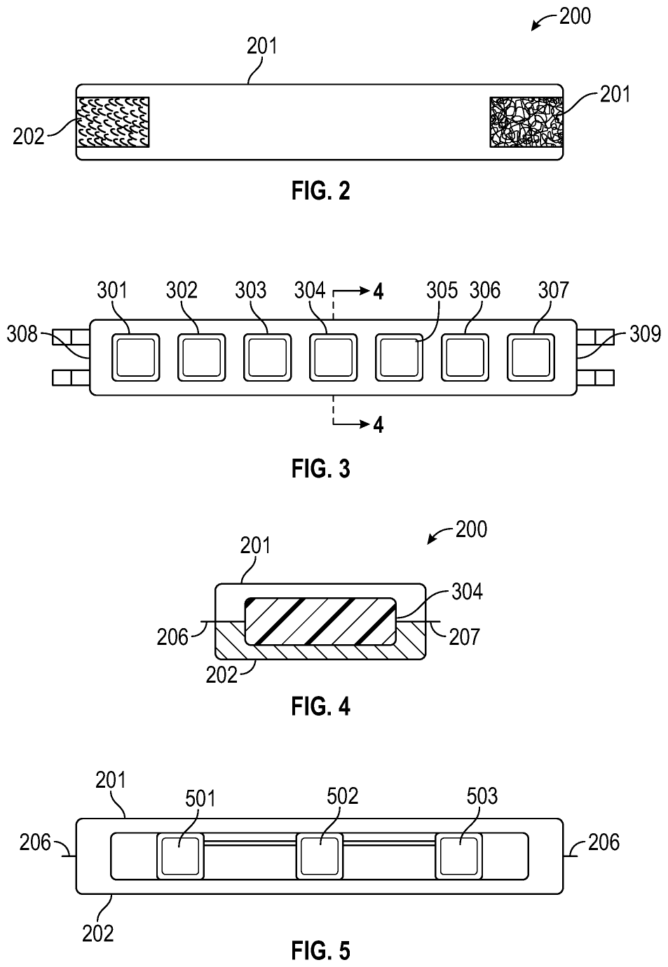

The invention consists of connected layered fabric straps sized to surround an equine foal's body at about the withers that has disposed on the straps a series of or a strip of inflatable bags that are attached by conduit to each other and by conduit to an inflator (pressure) means (hand air bulb pump or electric pump). A 4-6 inch wide webbing strap of non-rubbing seatbelt weave is very suitable for the strap. In general, the strap will be of significant length to surround a foal's body with sufficient additional length to fasten the ends together. A 36 to 40 inch length will generally be suitable. As shown in FIG. 1 (a simplified schematic of the connected layered straps) there is a surrounding strap 101, having an adjustable closure 106 (described in more detail below) and having a series of inflatable bags 102 and 103. The closure 104 and 105 that is illustrated is one-half of hook and loop fastener strips are to be attached (described below). FIG. 1A is a perspective view of the same and FIG. 2 is a top view showing placement of optional hook and loop straps, 201 and 202, one on top side and the other on the bottom side. The strap 200 may, in the alternative, be secured around a foal's body by buckles, or slip straps or any other suitable means that will allow the fabric strap to be adjustably connects to form a secure enclosing circumference around a foal's body. The structures 100 and 200 comprise two layers, 201 and 202 as shown in FIG. 4. The layers may be the same or different fabric. Items 206 and 207 illustrate the seam connecting the layers. In Fig. is a section AA view of FIGS. 3 and 304 is the same as 304 in FIG. 3. FIG. 4 is the top side of the bottom layer of 200 showing placement of inflatable bags 301, 302, 303, 304, 305, 306 and 307. The bags are interconnected as by a conduit. Items 308 and 309 are connection straps with buckle or slip buckles. FIG. 4 is an end view of an embodiment of FIG. 2 at section AA. Items 206 and 207 are the seams between the top side 201 and bottom side 202. FIG. 5 illustrates another embodiment wherein the inflatable bags are replaced by a single inflatable structure with partitions, 501, 502 and 503, to form a kind of bag structure singular to that of FIG. 3. The sections of the bags are interconnected by conduit.

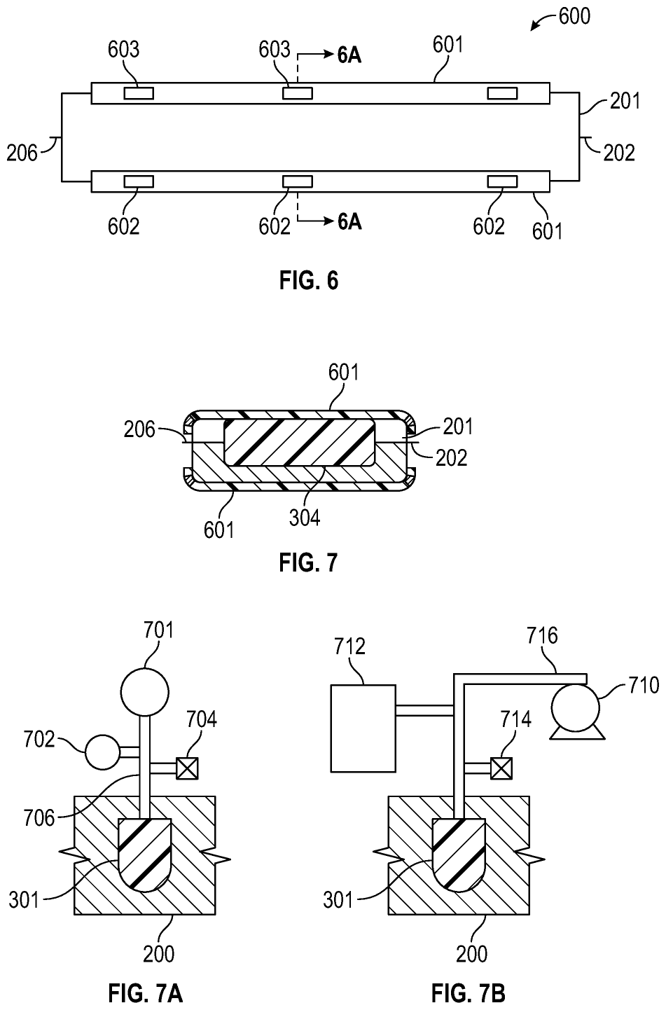

FIG. 6 illustrates an embodiment wherein there is attached to the inside, 202, (bottom side that will be next to the animal) a soft blanket or other fabric material, 601. It is removably attached, 602, to the bottom of the s strap 200 with edges folded over to be connected to the top side 201. FIG. 6A shows and section BB view.

The strip of hook and loop fasteners shown in FIGS. 1 and 1A may be attached directly to the inside surface of the surrounding strap or disposed on a soft fabric pad (as shown). The hook and loop strips may be multiple strips or an elongated strip to facilitate arranging the bags to a preferred location. In preferred embodiments, the inflatable bags are removably attached to a strip of hook and loop material attached to the surrounding strap and matching hook and loop strip attached to the bags. They may, however be permanently attached as by adhesive or stitching.

The bag or bags are connected to a pressuring source that may be a hand squeeze bulb, 701, (preferred) or an electric compressor to supply air to inflate the bags. A relief valve is may be provided to de-inflate the bags. Referring to FIGS. 7A and 7B, there is a pressure source 701 with as relief valve 704 connected by conduit 706 to inflatable bag or bags 301 (or in series or parallel to multiple bags) and a pressure gauge 702. In FIG. 7B the pressure source 710 is a pressure pump or pressure reservoir connected conduit 716 to a recorder controller 712. There is a relief valve 714. The relief valves can be set to ensure that too high pressure is not inadvertently applied (such as for example to relieve at about 15 psi). It may also be useful to provide a recording and controller on the system to record the time and pressure of a treatment as illustrated in FIG. 7B. This can be accomplished by an in-place pressure recorder of a sensor and transmitter to a remote recording device. The recording may be hard wired to the system or remotely connected as by a sensor and Bluetooth transmitter. In general, the pressure needs to be about 15 psi or less to obtain the necessary inflation. Generally, about 4-8 psi pressure and preferable about 6 psi of pressure on the sides of the foal is believed sufficient. As shown in the figures there are three sets of bags on each side of the surrounding fabric strap 100 and 200 and one on the bottom. This will provide pressure to the sided of the foal and under the belly. While this is deemed sufficient and preferred, there may be more or less bags and they may be sized differently. For example, there may be only one pad on each side that is longer and that has one or more strips of hook and loop fastener as in FIG. 5. This arrangement is designed to simulate the squeeze of the surrounding rope treatment described in the Background above which in turn is to simulate the time in the birth canal during a normal birth. In general, the pressure will be applied for about 15 to 30 minutes (10 minutes generally preferred) and is desirably accomplished on newborn foals within the first 10 hours after birth. “Newborn” as the term is used herein means within about 24 hours after birth. Thus, it is important that the device be easily usable at the site of birthing and not just in a clinical setting. A delay could be fatal. When the strap is released, the foal should stand and try to nurse if the treatment is successful. The timing and nature of the treatment is easily determined by trial and error.

The ends of the surrounding strap will have adjustable connectors that allow the strap to be tightened around the foal's body. There may also be provided a spreader bar to evenly spread the load of the surrounding strap for uniform loading. “Tightening” as the term is used herein, mean to pull the strap around the foal's body so that it is in substantial contact with the surface of the body under the strap.

The pressure source may be attached to the strap so as to be on the top or back of foal for connivance and easy access when the foal is standing as well as laying down.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense. Therefore, the scope of the invention should be limited only by the appended claims.

1. A device for treating equine neonatal maladjustment syndrome comprising:
a. two connected layered fabric straps having a top and bottom sized to be removable fitted and tightened around the body of a new born equine foal, said straps having disposed on the bottom surface an inflatable pressure bag or bags,
b. connection means to a pressure source, and
c. means to apply pressure to the bags to inflate them, the pressure mean being connected to the pressure bags by a conduit;

2. The device of claim 1 wherein the connection means b. is hook and loop fasteners, with one side of the fastener attached to the end of the layer fabric satrap and the other to the opposite end.

3. The device of claim 1 wherein the bag or bag are connected to the layer fabric strap by hook and loop fasteners.

4. The device of claim 1 wherein the straps in made of webbed fabric and is about 4 to 6 inches in width.

5. The device of claim 1 wherein there is also means for removable blanket to be attached to the bottom strap.

6. The device of claim 1 wherein there is pressure means for pressuring the bags comprising a squeeze bulb or electric pressure pump.

7. The device of claim 1 wherein there is also provided means for recording the pressure applied by the pressure and the duration of the pressure at each level.

8. A method of treating equine neonatal maladjustment syndrome comprising applying to the body a newborn foal a device comprising:
a. connected layered fabric straps sized to be removable fitted and tightened around the body of a new born equine foal having disposed on the inside surface of one the strap inflatable pressure bag or bags, connection means to a pressure source, and
b. means to apply pressure to the bags to inflate them, the pressure mean being connected to the pressure bags by a conduit;
c. tightening the device around the foal's body and inflating the bags therein to about 4 to 8 pounds pressure;
d. continuing to apply the pressure for 5 to 30 minutes and then releasing the pressure and removing the device.

9. The method of claim 8 wherein the bag or bag are connected to the layer fabric strap by hook and loop fasteners.

10. The method of claim 8 wherein the straps in made of webbed fabric and is about 4 to 6 inches in width.

11. The method of claim 8 wherein there is also means for removable blanket to be attached to the bottom strap.

10. An assembly comprising;
a. connected layered fabric straps sized to be removable fitted and tightened around the body of a new born equine foal having disposed on the inside surface of one the strap inflatable pressure bag or bags, connection means to a pressure source, and
b. means to apply pressure to the bags to inflate them, the pressure mean being connected to the pressure bags by a conduit;
c. tightening the device around the foal's body and inflating the bags therein to about 4 to 8 pounds pressure;
d. continuing to apply the pressure for 5 to 30 minutes and then releasing the pressure and removing the device;
e. and means to record the pressure applied.
